(19) United States
(12) Patent Application Publication
(10) Pub. No.: US 2021/0097425 A1
(43) Pub. Date: Apr. 1, 2021

(54) HUMAN-UNDERSTANDABLE MACHINE INTELLIGENCE

(71) Applicant: Microsoft Technology Licensing, LLC, Redmond, WA (US)

(72) Inventors: Jilei Yang, Sunnyvale, CA (US); Yongzheng Zhang, San Jose, CA (US); Shen Huang, San Jose, CA (US); Burcu Baran, Sunnyvale, CA (US); Chi-Yi Kuan, Fremont, CA (US)

(21) Appl. No.: 16/584,623

(22) Filed: Sep. 26, 2019

(51) Int. Cl. G06N 20/00; G06F 17/27

(52) U.S. Cl. CPC G06N 20/00; G06F 17/2785

(57) ABSTRACT

The disclosed embodiments provide a system for processing data. During operation, the system determines output of a machine learning model, which includes a score generated by the model based on features inputted into the model and feature importance metrics representing effects of the features on the score. Next, the system maps the features to elements in a feature hierarchy that groups the features under a first level of parent features. The system also generates a ranking of the first level of parent features based on the feature importance metrics. The system then combines, based on the ranking, feature values of the mapped features with a set of insight templates to produce a list of narrative insights, wherein each narrative insight includes a natural language description of a factor that contributes to the model's output. Finally, the system outputs the list of narrative insights in a user interface.

### BACKGROUND

### Field

The disclosed embodiments relate to machine learning. More specifically, the disclosed embodiments relate to techniques for producing human-understandable machine intelligence.

### Related Art

Analytics is commonly used to discover trends, patterns, relationships, and/or other attributes related to large sets of complex, interconnected, and/or multidimensional data. In turn, the discovered information is used to derive insights and/or guide decisions or actions related to the data. For example, business analytics may be used to assess past performance, guide business planning, and/or identify actions that may improve future performance

To glean such insights, large datasets of features are analyzed using regression models, artificial neural networks, support vector machines, decision trees, naïve Bayes classifiers, and/or other types of machine learning models. The discovered information can then be used to guide decisions and/or perform actions related to the data. For example, the output of a machine learning model is used to guide marketing decisions, assess risk, detect fraud, predict behavior, and/or customize or optimize use of an application or website.

However, significant time, effort, and overhead are spent on feature selection during creation and training of statistical models for analytics. For example, a data set for a machine learning model may have thousands to millions of features, including features that are created from combinations of other features, while only a fraction of the features and/or combinations may be relevant and/or important to the machine learning model. At the same time, training and/or execution of statistical models with large numbers of features typically require more memory, computational resources, and time than those of machine learning models with smaller numbers of features. Excessively complex models that utilize too many features may additionally be at risk for overfitting.

At the same time, machine learning models are commonly associated with a tradeoff between interpretability and performance For example, a linear regression model may include coefficients that identify the relative weights or importance of features in the model but does not perform well with complex problems. Conversely, a nonlinear model such as a random forest or gradient boosted trees can be trained to perform well with a variety of problems but typically operates in a way that is not easy to understand.

Moreover, end users that consume machine learning output commonly have difficulty understanding the operation and output of machine learning models. For example, a machine learning model outputs scores representing likelihoods of positive and/or negative outcomes within a certain domain End users that are experts in the domain may use the scores to develop strategies and/or prioritize certain projects or tasks over others (e.g., in a way that maximizes positive or desired outcomes). However, the users may lack knowledge of predictive modeling that allows the users to understand the value of a given score, quantitatively distinguish between similar scores (e.g., 0.7 and 0.8), and/or understand lists of “top” features that affect the scores. As a result, the users may misinterpret and/or fail to fully utilize the insights generated by the machine learning model.

Consequently, machine learning and/or analytics may be facilitated by mechanisms for improving the creation, profiling, management, sharing, selection, and understanding of features and/or machine learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the process of data in accordance with the disclosed embodiments.

FIG. 4 shows a flowchart illustrating a process of generating a ranking of parent features in a feature hierarchy in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for processing output from machine learning models. The output includes scores representing predictions, estimates, and/or inferences by the machine learning models of propensities, preferences, behavior, categories, and/or other attributes of users, companies, jobs, items, and/or other entities. The output also, or instead, includes a list of the most important features for a given score produced by a machine learning model and/or feature importance metrics representing the effects of features inputted into the machine learning model on the score.

More specifically, the disclosed embodiments provide a method, apparatus, and system for converting machine learning model output into a human-understandable representation. For example, the score outputted by a model and/or features with the greatest effect on the score are converted into a set of “narrative insights.” The narrative insights include a natural language explanation of the score's significance (e.g., a characterization of a likelihood or probability represented by the score) and natural language descriptions of factors that contribute to the score (e.g., sentences that include definitions of feature values, comparisons of feature values, and/or percentage changes in the feature values over time).

A number of structures are involved in generating human-understandable narrative insights from the corresponding scores and/or features. The structures include a configurable feature hierarchy groups features inputted into the machine learning model under one or more levels of parent features. Within the feature hierarchy, each parent feature represents a common concept, definition, and/or redundancy among child features grouped under the parent feature. As a result, the feature hierarchy can be used to organize potentially large sets of features into semantically related groupings.

For example, the feature hierarchy includes groupings of features inputted into machine learning models under a first level of parent features. Each first-level parent feature represents a common concept applied to child features grouped under the parent feature (e.g., a first-level parent feature of “clicks” includes child features of “clicks last month,” “clicks this month,” and/or “cost per click”). The feature hierarchy also, or instead, includes groupings of two or more first-level parent features under a second, higher level of parent features. Each second-level parent feature represents a commonality or redundancy in definition for first-level parent features grouped under the parent feature (e.g., a second-level parent feature of “searches” includes child features of “average searches per user” and “total searches by users”).

The structures also include configurable and/or user-specified insight templates containing text that describes and/or defines one or more features, as well as “slots” or “positions” for the corresponding features. For example, an insight template for a “month-over-month change” insight is represented as “{feature name} has a month-over-month change of {previous value} to {current value}.” In the insight template, brackets around “feature name,” “previous value,” and “current value” represent placeholders for the corresponding features in the feature hierarchy and/or input into a machine learning model. Each insight template is also associated with one or more parent features in the feature hierarchy. Continuing with the above example, the “month-over-month change” insight is mapped to some or all parent features in the feature hierarchy that contain child features representing metrics that are tracked over a current month and/or one or more previous months.

To generate human-understandable narrative insights from a score outputted by a machine learning model and features inputted into the model to produce the score, metadata for the features is mapped to elements in the feature hierarchy and/or placeholders in insight templates. For example, identifiers, transformations, and/or other attributes of individual features used by the machine learning model are mapped to one or more levels of parent features in the feature hierarchy. The attributes are also, or instead, mapped to feature positions and/or placeholders in insight templates associated with the parent features.

Next, some or all parent features in the feature hierarchy are ranked based on feature importance metrics for child features of the parent features. For example, an overall score for each first-level parent feature in the feature hierarchy is calculated as the highest feature importance metric associated with a child feature of the first-level parent feature, and the first-level parent features are ranked by descending overall score. When two or more first-level parent features in the ranking are grouped under a second-level parent feature in the feature hierarchy, the first-level parent feature with the highest overall score is retained in the ranking, and all other first-level parent features under the same second-level parent feature are removed from the ranking to reduce the redundancy of information in the narrative insights.

Feature values associated with some or all of the ranked parent features are then combined with the corresponding insight templates to generate narrative insights describing the corresponding set of output from the machine learning model. For example, the feature values are inserted into the positions of the corresponding features in the insight templates to produce human-readable sentences explaining the model's output. Narrative insights associated with the highest-ranked parent features in the ranking are then outputted in a user interface to users consuming the output.

By converting output from machine learning models into human-understandable narrative insights, the disclosed embodiments improve understanding of the output by users. As a result, the users may perform less querying, browsing, searching, filtering, and/or sorting of raw feature names, feature values, scores, and/or other representations of data produced and/or processed by the machine learning models, which reduces processing and/or load on computer systems, applications, and/or user interfaces used to carry out the querying, browsing, searching, filtering, and/or sorting. The users are also better able to convert the output into actions that can be performed to achieve goals related to the output. When the actions are carried out using computer systems, applications, and/or other technologies (e.g., messaging, targeting, monitoring, automation, etc.), unnecessary processing performed by the technologies to carry out extraneous actions by the users (e.g., actions based on misinterpretation and/or a lack of understanding of the output by the users) is reduced. Consequently, the disclosed embodiments improve computer systems, applications, user experiences, tools, and/or technologies related to developing and/or evaluating machine learning models and/or analyzing or utilizing the output of the machine learning models.

### Human-Understandable Machine Intelligence

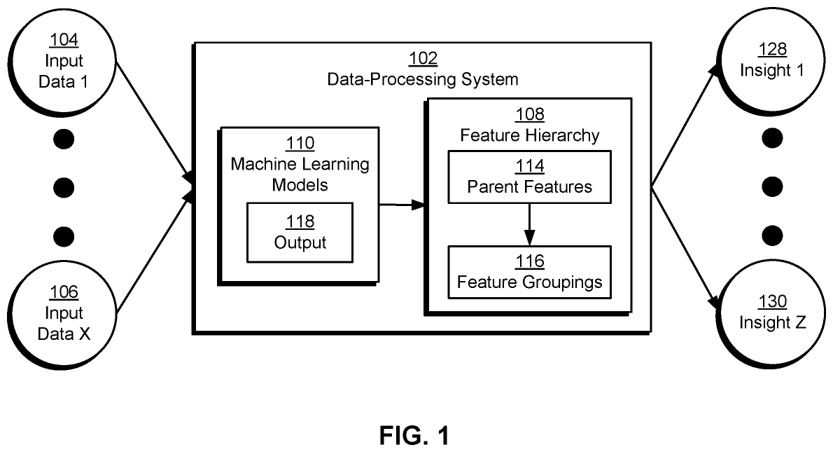

FIG. 1 shows a schematic of a system in accordance with the disclosed embodiments. As shown in FIG. 1, the system includes a data-processing system 102 that analyzes one or more sets of input data (e.g., input data 1 104, input data x 106). More specifically, data-processing system 102 may train and/or execute one or more machine learning models 110 that analyze input data related to users, organizations, applications, job postings, purchases, electronic devices, network devices, images, audio, video, websites, content, sensor measurements, and/or other categories. Machine learning models 110 include, but are not limited to, regression models, artificial neural networks, support vector machines, decision trees, random forests, gradient boosted trees, naïve Bayes classifiers, Bayesian networks, deep learning models, clustering techniques, collaborative filtering techniques, hierarchical models, and/or ensemble models.

In one or more embodiments, analysis performed by data-processing system 102 is used to discover relationships, patterns, and/or trends in the data; gain insights from the input data; and/or guide decisions or actions related to the data. For example, data-processing system 102 uses machine learning models 110 to generate output 118 that includes scores, classifications, recommendations, estimates, predictions, and/or other inferences or properties.

In some embodiments, output 118 is inferred or extracted from primary features in the input data and/or derived features that are generated from primary features and/or other derived features. For example, the primary features include profile data, user activity, sensor data, and/or other data that is extracted directly from fields or records in the input data. The primary features are aggregated, scaled, combined, bucketized, and/or otherwise transformed to produce derived features, which in turn may be further combined or transformed with one another and/or the primary features to generate additional derived features. After output 118 is generated from one or more sets of primary and/or derived features, output 118 is queried and/or otherwise used to improve revenue, interaction with the users and/or organizations, performance and/or use of the applications and/or devices, and/or other metrics associated with the input data.

In one or more embodiments, data-processing system 102 includes functionality to generate human-understandable insights (e.g., insight 1 128, insight z 130) that explain output 118 of machine learning models 110. As described in further detail below, such insights are mapped to components of a configurable feature hierarchy 108 that includes feature groupings 116 under higher-level parent features 114, as well as representations and/or values of features used with machine learning models 110. The mappings allow values of the features to be combined with templates for the insights into narrative insights containing natural language sentences that describe, define, and/or provide context related to output 118.

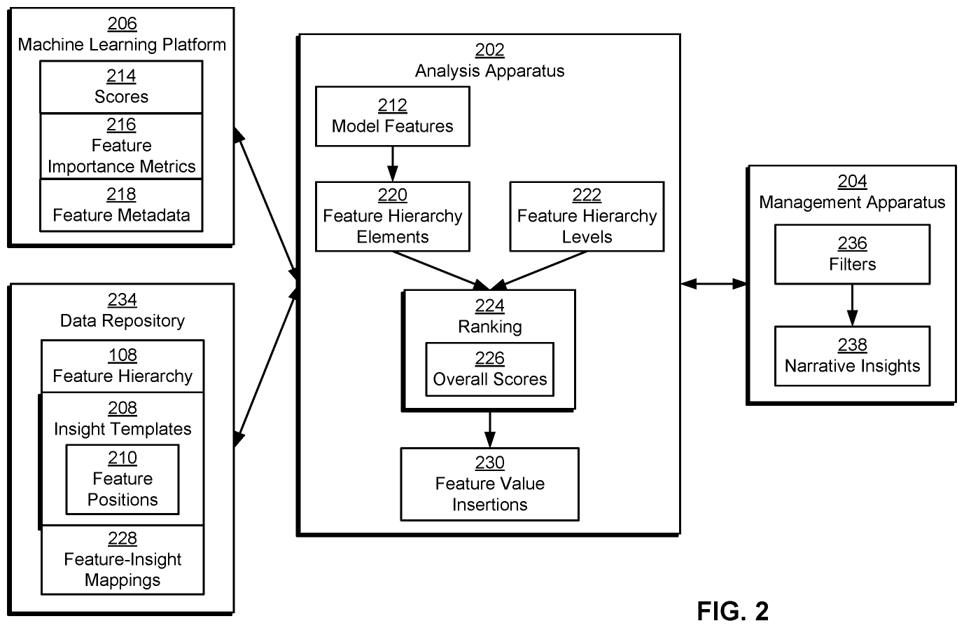

FIG. 2 shows a system for processing data (e.g., data-processing system 102 of FIG. 1) in accordance with the disclosed embodiments. The system includes an analysis apparatus 202 and a management apparatus 204. Each of these components is described in further detail below.

Analysis apparatus 202 combines output from a machine learning platform 206 with data in a data repository 234 to produce a set of narrative insights 238 related to the output. As shown in FIG. 2, output of machine learning platform 206 includes scores 214 generated by one or more machine learning models (e.g., machine learning models 110 of FIG. 1) from input features, feature importance metrics 216 representing effects of the input features on each score, and feature metadata 218 for the features.

For example, machine learning platform 206 includes functionality to perform training and/or inference using one or more machine learning models. During training, machine learning platform 206 uses a training technique and/or one or more hyperparameters to fit each machine learning model to a training dataset. Machine learning platform 206 then performs inference using the same machine learning model by applying the machine learning model to a set of input feature values to produce one or more scores 214. Each score includes a value ranging from 0 to 1 that represents a predicted likelihood of an outcome (e.g., user action, event, result, etc.) associated with an entity represented by the inputted feature values.

Continuing with the above example, machine learning platform 206 also calculates and/or obtains feature importance metrics 216 as regression coefficients, feature weights, random forest impurity decreases, and/or other measures of importance and/or impact of individual features and/or feature values on the score(s). Machine learning platform 206 additionally obtains and/or generates feature metadata 218 that includes, but is not limited to, raw feature names, identifiers (IDs), values, locations, descriptions, transformations, and/or other information related to the inputted feature values. Finally, machine learning platform 206 generates, for each set of feature values inputted into the machine learning model, output that includes a corresponding score or set of scores 214, feature importance metrics 216 for the inputted set of feature values, and feature metadata 218 for the feature values.

Data repository 234 stores data that can be used to convert output from machine learning platform 208 into narrative insights 238. The data includes feature hierarchy 108, a set of insight templates 208, and a set of feature-insight mappings 228.

As mentioned above, feature hierarchy 108 groups features that are available as input into machine learning models (e.g., features used with the machine learning models by machine learning platform 206) under parent features in one or more feature hierarchy levels 222. In some embodiments, each parent feature in feature hierarchy 108 represents a common definition, category, and/or concept for features grouped under the parent feature. As a result, feature hierarchy 108 is used to organize large numbers of disparate features into semantically related groupings.

For example, the feature hierarchy includes groupings of features under two levels of parent features. The first level of the feature hierarchy includes “super features” that are parents of features inputted into the machine learning model. Each super feature represents a common concept or definition for child features grouped under the super feature (e.g., a super feature of “clicks” includes child features of “clicks last month,” “clicks this month,” and/or “cost per click”).

Continuing with the above example, the feature hierarchy also includes groupings of first-level super features under a second, higher level of “ultra features.” Each ultra feature in the second level represents a commonality, redundancy, or overlap in definition for first-level super features grouped under the ultra feature (e.g., an ultra feature of “searches” includes child super features of “average searches per user” and “total searches by users”).

Insight templates 208 contain pre-specified and/or user-generated data that can be used to generate human-understandable narrative insights 238 from scores 214, feature importance metrics 216, and/or feature metadata 218. Each insight template includes text that describes and/or defines one or more parent features and/or feature groupings in feature hierarchy 108, as well feature positions 210 that are used as placeholders for feature values related to the parent features and/or feature groupings.

For example, an insight template for a “month-over-month change” insight is represented as “{feature name} has a month-over-month change of {previous value} to {current value}.” In the insight template, bracketed values of “feature name,” “previous value,” and “current value” represent slots or placeholders (i.e., feature positions 210) for the corresponding attributes in feature metadata 218. To convert the insight template into a narrative insight for a given set of output from machine learning platform 206, a feature name, previous value, and current value of a given feature are obtained from feature metadata 218 in the output and inserted into the corresponding feature positions 210 in the insight template.

Feature-insight mappings 228 include mappings between elements of feature hierarchy 108 and insight templates 208. In some embodiments, each feature-insight mapping identifies one or more insight templates 208 that can be used to generate narrative insights 238 for groupings of features in feature hierarchy 108. For example, feature-insight mappings 228 include mappings from individual first-level parent features in feature hierarchy 108 to names or identifiers of insight templates 208 (e.g., the “month-over-month change” insight is mapped to some or all first-level parent features in feature hierarchy 108 that contain child features representing metrics that are tracked over a current month and/or one or more previous months). As a result, one or more child features grouped under a first-level parent feature in feature hierarchy 108 can be used to populate an insight template to which the first-level parent feature is mapped in feature-insight mappings 228.

In one or more embodiments, analysis apparatus 202 uses feature hierarchy 108, insight templates 208, and feature-insight mappings 228 to convert scores 214, feature importance metrics 216, and feature metadata 218 in a given set of output from machine learning platform 206 into one or more narrative insights 238 that explain the output in a human-understandable manner First, analysis apparatus 202 associates model features 212 (i.e., representations of features as inputted into a machine learning model) in feature metadata 218 with feature hierarchy elements 220 in feature hierarchy 108.

For example, analysis apparatus 202 generates a mapping of one or more attributes in feature metadata 218 (e.g., feature name, value, ID, location, description transformation, etc.) for a model feature to a first-level parent feature (i.e., a “super feature”) of the feature and/or a second-level parent feature (e.g., an “ultra feature”) above the first-level parent feature in feature hierarchy 108. Analysis apparatus 202 optionally updates the mapping to include a name or identifier of an insight template for one or both parent-level features and/or a feature position (i.e., placeholder) in the insight template. As a result, analysis apparatus 202 establishes associations among model features 212, feature hierarchy elements 220, and/or insight templates 208 to improve and/or streamline subsequent processing using model features 212, feature hierarchy 108, and insight templates 208.

In one or more embodiments, analysis apparatus 202 further associates feature positions 210 in insight templates 208 with values of model features 212. Continuing with the above example, analysis apparatus 202 updates the mapping so that an identifier for each feature position in the mapping is assigned a value of the feature to which the feature position is mapped.

Analysis apparatus 202 also includes functionality to calculate metrics, statistics, and/or other derived values from model features 212 during or after mapping of model features 212 to feature hierarchy elements 220 in feature hierarchy 108. These calculations are performed when one or more model features 212 are mapped to groupings of features in feature hierarchy 108 and/or insight templates 208 that include these derived values.

For example, feature hierarchy 108 and/or insight templates 208 include derived values representing changes to features over time, ratios of two feature values, and/or an aggregate value of a feature for a segment of entities associated with output by the machine learning model. An insight template that includes a change to a feature over time includes the following: “{super feature name} changed from {previous value} to {current value} ({percentage change} %) in the last month.” An insight template that includes a ratio of two feature values includes the following: “{super feature name} is {value} ({ratio}% of total).” An insight template that includes an aggregate value of a feature includes the following: “{super feature name} is {value} (peer average: {segment average value}).”

When analysis apparatus 202 encounters a derived value in a grouping of features in feature hierarchy 108 and/or in an insight template after mapping the grouping or insight template to one or more model features 212, analysis apparatus 202 calculates the derived value and associates the derived value with the corresponding element in feature hierarchy 108 and/or feature position in the insight template. Continuing with the above example, analysis apparatus 202 calculates a value of the “percentage change” attribute in the first insight template by subtracting the “current value” attribute from the “previous value” attribute and dividing the result by “previous value.” Analysis apparatus 202 calculates a value of the “ratio” attribute in the second insight template by dividing the “value” attribute by another attribute representing a total value associated with the super feature, which does not have a placeholder or position in the insight template. Analysis apparatus 202 calculates a value of the “segment average value” in the third insight template by averaging the “value” attribute across all sets of features associated with the same segment as the entity to which the “value” attribute pertains in a given set of output.

Next, analysis apparatus 202 generates a ranking 224 of some or all feature hierarchy elements 220 based on mappings of model features 212 to feature hierarchy elements 220, one or more feature hierarchy levels 222 in feature hierarchy 108, and feature importance metrics 216 for model features 212. In one or more embodiments, analysis apparatus 202 generates ranking 224 based on overall scores 226 associated with parent features in one or more feature hierarchy levels 222. In turn, overall scores 226 are based on feature importance metrics 216 of model features 212 mapped to child features grouped under the parent features.

For example, analysis apparatus 202 calculates an overall score for each first-level parent feature in feature hierarchy 108 as the highest feature importance metric associated with a child feature of the first-level parent feature and/or another aggregation (e.g., sum, average, median, etc.) of feature importance metrics 216 for child features grouped under the first-level parent feature. Analysis apparatus 202 then generates ranking 224 by ordering the first-level parent features by descending overall scores 226. When two or more first-level parent features in ranking 224 are grouped under a second-level parent feature in feature hierarchy 108, analysis apparatus 202 keeps only the first-level parent feature with the highest overall score in ranking 224 to reduce the redundancy of information in narrative insights 238 generated from first-level parent features in ranking 224.

As a result, each element of ranking 224 represents a concept or definition shared by one or more features used to generate the set of output, which has been deduplicated with redundant concepts or definitions shared by other features used to generate the same set of output. In addition, elements in ranking 224 are ordered so that features or concepts with greater impact on the output are ranked higher than features or concepts with less impact on the output.

Analysis apparatus 202 then uses ranking 224 to perform feature value insertions 230 of model features 212 into the corresponding feature positions 210 in insight templates 208. For example, analysis apparatus 202 uses mappings of model features 212 to feature hierarchy elements 220 and/or insight templates 208 to insert feature values into the corresponding feature positions 210 in insight templates 210. After a given insight template is populated with the relevant feature values, the insight template is converted into a narrative insight containing a human-readable sentence explaining the output.

After narrative insights 238 are produced for a given set of output from machine learning platform 206, analysis apparatus 202 stores narrative insights 238 in data repository 234 and/or another data store. Analysis apparatus also, or instead, provides narrative insights 238 to management apparatus 204 for subsequent delivery to one or more users.

In one or more embodiments, management apparatus 204 includes functionality to output narrative insights 238 to the users. For example, management apparatus 204 obtains narrative insights 238 from analysis apparatus 202, data repository 234, and/or another component of the system. Management apparatus 204 then generates output representing narrative insights 238 in a graphical user interface (GUI), web-based user interface, mobile user interface, command line interface (CLI), voice user interface, and/or another type of interface that allows users to access narrative insights 238. In another example, management apparatus 204 transmits an email, alert, notification, message, and/or another communication containing narrative insights 238 and/or a link to narrative insights 238 (e.g., a Uniform Resource Locator (URL) to a file containing narrative insights 238) to the users.

To improve the application of narrative insights 238 to the corresponding output from machine learning platform 206, management apparatus 204 applies one or more optional filters 236 to narrative insights 238 before outputting narrative insights 238 to the users. For example, management apparatus 204 obtains a blacklist of first-level parent features from data repository 234 and/or another data store. The blacklist includes features that are deemed to be meaningless and/or unhelpful to understanding the output. Management apparatus 204 then filters narrative insights 238 to prevent any narrative insights 238 associated with features in the blacklist from being displayed or outputted to the users.

In another example, management apparatus 204 applies a threshold to a narrative insight that includes a change in value (e.g., a change in a numeric feature from the previous month to the current month). When the change in value does not meet the threshold (e.g., if the change in the feature value is less than a percentage threshold), management apparatus 204 omits outputting the narrative insight to the users.

In a third example, management apparatus 204 obtains a maximum number of narrative insights 238 to output. Management apparatus 204 orders narrative insights 238 within a list according to the positions of the corresponding first-level features in ranking 224. Management apparatus 204 then outputs some or all narrative insights 238 in the list, starting at the top of the list and ending when the maximum number of narrative insights 238 or the end of the list is reached, whichever comes first.

In some embodiments, analysis apparatus 202, management apparatus 206, and/or another component of the system additionally include functionality to convert one or more scores 214 in a given set of output from machine learning platform 206 into an additional narrative insight that is included in the outputted narrative insights 238. For example, the component obtains, from data repository 234 and/or another data source, one or more ranges of scores values for each score in the output (e.g., 0-0.2, 0.2-0.4, 0.4-0.7, 0.7-0.9, 0.9-1), as well as a natural language phrase explaining the significance of score values in each range (e.g., “highly unlikely,” “unlikely,” “moderately likely,” “very likely,” “extremely likely”). The component then matches the score's value in the output to a corresponding range and selects the natural language phrase to which the range is mapped as the narrative insight for the score.

The operation of the system of FIG. 2 is illustrated using the following example. First, analysis apparatus 202 obtains eight features named “job qty,” “job price,” “paid jobs previous month,” “paid jobs current month,” “job views previous month,” “job views current month,” “job viewers previous month,” and “job viewers current month” from feature metadata 218 for a set of output from machine learning platform 206.

Analysis apparatus 202 maps the feature names and additional feature metadata 218 for the features to data in data repository 234 to produce the following table:

| | | | Insight | Insight |
|---|---|---|---|---|
| | Super | Ultra | Template | Template |
| Feature | Feature | Feature | Name | Position |
| job qty | job slots since | job slots since | quantity | quantity num |
| | last contract | last contract | | |
| | renewal | renewal | | |
| job price | job slots since | job slots since | quantity | total price |
| | last contract | last contract | | |
| | renewal | renewal | | |
| paid jobs | paid job posts | paid job posts | monthly | prev value |
| previous month | | | value change | |
| paid jobs | paid job posts | paid job posts | monthly | current value |
| current month | | | value change | |
| job views | views per job | job views | monthly | prev value |
| previous month | | | value change | |
| job views | views per job | job views | monthly | current value |
| current month | | | value change | |
| job viewers | viewers per job | job views | monthly | prev value |
| previous month | | | value change | |
| job viewers | viewers per job | job views | monthly | current value |
| current month | | | value change | |

More specifically, analysis apparatus 202 maps each feature name to a corresponding super feature and ultra feature in feature hierarchy 108, as well as an insight template name of an insight template in data repository 234 and a name of a feature position in the insight template.

Next, analysis apparatus 202 groups the mappings by insight template name and assigns feature values used to generate the set of output to the corresponding feature positions 210 in each insight template:

| | | Insight | Insight |
|---|---|---|---|
| Super | Ultra | Template | Template |
| Feature | Feature | Name | Position |
| job slots since last | job slots since last | quantity | quantity num: 10 |
| contract renewal | contract renewal | | total price: 10,000 |
| paid job posts | paid job posts | monthly value | prev value: 10 |
| | | change | current value: 15 |
| views per job | job views | monthly value | prev value: 200 |
| | | change | current value: 300 |
| viewers per job | job views | monthly value | prev value: 300 |
| | | change | current value: 400 |

Analysis apparatus 202 also obtains the following feature importance metrics 216 from the set of output:

| Feature | Metric |
|---|---|
| paid jobs current month | 0.0279 |
| job views current month | 0.0128 |
| job viewers current month | 0.0115 |
| job price | 0.0102 |
| job qty | 0.0089 |
| job viewers previous month | 0.0060 |

Analysis apparatus 202 then generates ranking 224 of the super features by overall scores 226, with the overall score of a given super feature set to the highest feature importance metric of a feature grouped under the super feature. Because the “paid jobs current month” feature has the highest feature importance metric, the corresponding super feature of “paid job posts” is first in ranking 224. The second highest feature importance metric for the “job views current month” feature maps to the “views per job” super feature, which is included in the second position of ranking 224. The third highest feature importance metric for the “job viewers current month” feature maps to the “viewers per job” super feature, which is included in the third position of ranking 224. The fourth highest feature importance metric for the “job price” feature maps to the “job slots since last contract renewal” super feature, which is included in the fourth position of ranking 224.

Analysis apparatus 202 additionally deduplicates super features grouped under the same ultra feature in ranking 224. In particular, analysis apparatus 202 determines that the “views per job” and “viewers per job” super features share the same ultra feature of “job views” and removes the lower-ranked “viewers per job” super feature from ranking 224.

Analysis apparatus 202 then combines (e.g., joins) ranking 224 with the previously generated mappings of feature names and values to super features, ultra features, insight template names, and insight template feature positions 210 to produce the following table of ranked super features and corresponding ultra features, insight template names, and feature positions and values for the corresponding insight templates 208:

| | | Insight | Insight |
|---|---|---|---|
| Super | Ultra | Template | Template |
| Feature | Feature | Name | Position |
| paid job posts | paid job posts | monthly value | prev value: 10 |
| | | change | current value: 15 |
| job slots since last | job slots since last | quantity | quantity num: 10 |
| contract renewal | contract renewal | | total price: 10,000 |
| views per job | job views | monthly value | prev value: 200 |
| | | change | current value: 300 |

Analysis apparatus 202 also retrieves the “monthly value change” and “quantity” insight templates 208 from data repository 234. The “monthly value change” insight template includes the following: “{super feature name} changed from {previous value} to {current value} ({change percentage} %) in the last month.” The “quantity” insight template includes the following: “{quantity num} {super feature name} purchased for {total price}.”

Finally, analysis apparatus 202 inserts feature values in the table into the corresponding feature positions 210 in the retrieved insight templates 208 to produce the following list of narrative insights 238:

1. Paid job posts changed from 10 to 15 (+50%) in the last month

2. 10 job slots since last contract renewal purchased for $10,000

3. Views per job changed from 200 to 300 (+50%) in the last month

By converting output from machine learning models into human-understandable narrative insights, the disclosed embodiments improve understanding of the output by users. As a result, the users may perform less querying, browsing, searching, filtering, and/or sorting of raw feature names, feature values, scores, and/or other representations of data produced and/or processed by the machine learning models, which reduces processing and/or load on computer systems, applications, and/or user interfaces used to carry out the querying, browsing, searching, filtering, and/or sorting. The users are also better able to convert the output into actions that can be performed to achieve goals related to the output. When the actions are carried out using computer systems, applications, and/or other technologies (e.g., messaging, targeting, monitoring, automation, etc.), unnecessary processing performed by the technologies to carry out extraneous actions by the users (e.g., actions based on misinterpretation and/or a lack of understanding of the output by the users) is reduced. Consequently, the disclosed embodiments improve computer systems, applications, user experiences, tools, and/or technologies related to developing and/or evaluating machine learning models and/or analyzing or utilizing the output of the machine learning models.

Those skilled in the art will appreciate that the system of FIG. 2 may be implemented in a variety of ways. First, analysis apparatus 202, management apparatus 204, and/or data repository 234 may be provided by a single physical machine, multiple computer systems, one or more virtual machines, a grid, one or more databases, one or more filesystems, and/or a cloud computing system. Analysis apparatus 202 and management apparatus 204 may additionally be implemented together and/or separately by one or more hardware and/or software components and/or layers.

Second, data used by the system may be stored, defined, and/or transmitted using a number of techniques. For example, the system may be configured to retrieve feature hierarchy 108, insight templates 208, and/or feature-insight mappings 228 from different types of repositories, including relational databases, graph databases, data warehouses, filesystems, and/or flat files. The system may also obtain and/or transmit scores 214, feature importance metrics 216, feature metadata 218, feature hierarchy 108, insight templates 208, feature-insight mappings 228, ranking 224, and/or narrative insights 238 in a number of formats, including database records, property lists, Extensible Markup language (XML) documents, JavaScript Object Notation (JSON) objects, and/or other types of structured data.

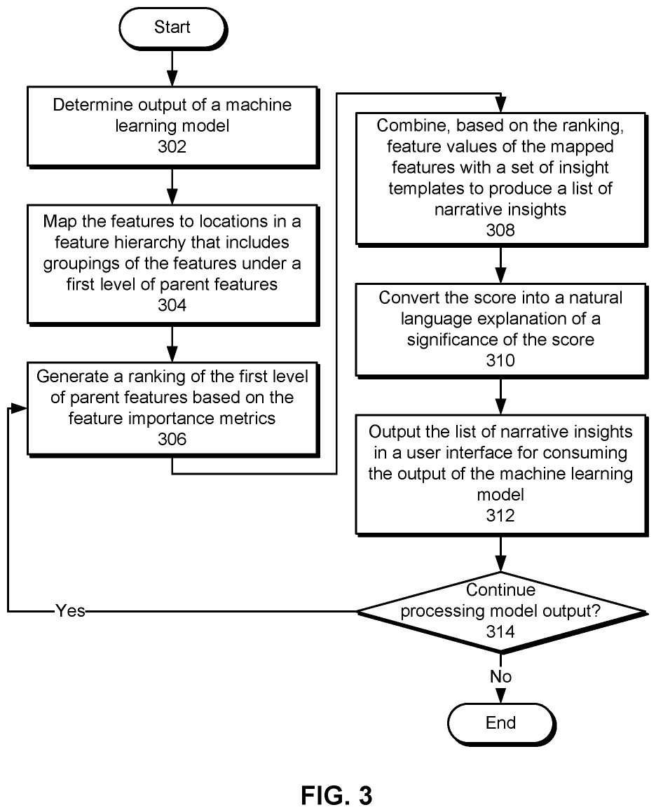

FIG. 3 shows a flowchart illustrating the process of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, output of a machine learning model is determined (operation 302). For example, the output includes a score produced by the machine learning model, feature values and/or other metadata for features inputted into the machine learning model to produce the score, and/or feature importance metrics representing effects of the features on the score. The output is obtained from and/or generated by a machine learning platform that performs training of and/or inference using the machine learning model.

Next, the features are mapped to elements in a feature hierarchy that includes groupings of the features under a first level of parent features (operation 304). For example, identifiers, values, locations, transformations, and/or other attributes of the feature metadata are mapped to representations of the corresponding features in the feature hierarchy and/or one or more levels of parent features under which the features are grouped in the feature hierarchy. Feature values of the features are optionally transformed, and one or more metrics (e.g., a change in a feature value over time, a ratio of two feature values, an aggregate value of a feature for a set of entities associated with scores outputted by the machine learning model, etc.) are optionally calculated from feature values grouped under a parent feature in the feature hierarchy.

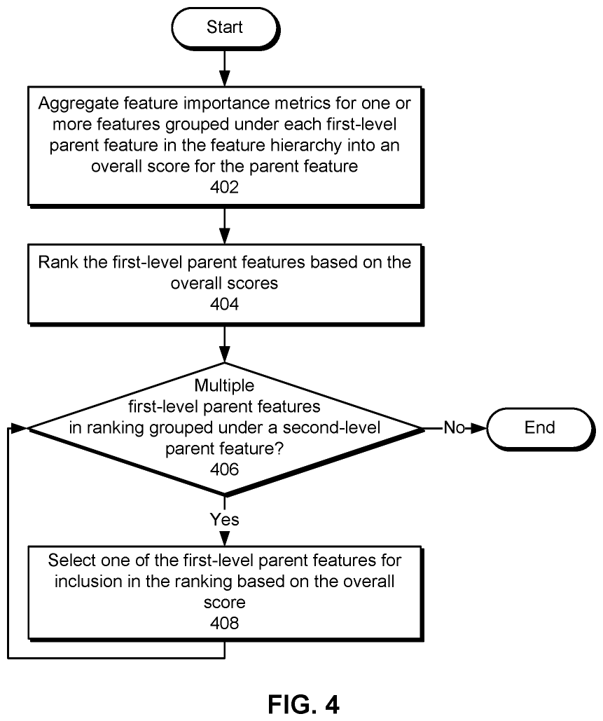

A ranking of the first level of parent features is generated based on the feature importance metrics (operation 306), as described in further detail below with respect to FIG. 4. Feature values of the mapped features are then combined with a set of insight templates based on the ranking to produce a list of narrative insights (operation 308). For example, the list includes narrative insights that are ordered to reflect the ranking of parent features generated in operation 306. Each narrative insight is created by inserting feature values of one or more features mapped to the corresponding parent feature into positions of and/or placeholders for the feature(s) in an insight template for the parent feature. In turn, the narrative insight includes a natural language description of a factor that contributes to the output of the machine learning model.

The score is also converted into a natural language explanation of a significance of the score (operation 310). For example, a range of scores containing the score is identified, and the natural language explanation of the significance of the range of scores is retrieved and assigned to the score as an additional narrative insight related to the output.

Finally, a list of the narrative insights (including the natural language explanation of the score's significance) is outputted in a user interface for consuming the output of the machine learning model (operation 312). For example, the score is displayed in a GUI, along with the natural language explanation of the score's significance. The list of narrative insights is also displayed to allow one or more users interacting with the user interface to interpret or understand the score and/or definitions, concepts, or values related to features used to produce the score. One or more filters are optionally applied to the narrative insights prior to outputting the narrative insights in the GUI. The filters include, but are not limited to, one or more parent features to omit from the list of narrative insights, a maximum number of narrative insights to output, and/or a minimum change in a feature.

Operations 302-312 may be repeated during continued processing of model output (operation 314). For example, narrative insights may be generated and outputted in the user interface for additional sets of output produced by the machine learning model.

FIG. 4 shows a flowchart illustrating a process of generating a ranking of parent features in a feature hierarchy in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, feature importance metrics are aggregated for one or more features grouped under each first-level parent feature in the feature hierarchy into an overall score for the parent feature (operation 402). For example, a given first-level parent feature in the feature hierarchy includes one or more child features inputted into a machine learning model. The output includes feature importance metrics representing the effects of the features on the resulting score generated by the machine learning model from the features. As a result, an overall score for the first-level parent feature can be obtained as the highest feature importance metric assigned to a child feature of the first-level parent feature, an average value of all feature importance metrics assigned to child features of the first-level parent feature, and/or another statistic calculated from feature importance metrics for the child features.

Next, the first-level parent features are ranked based on the overall scores (operation 404). For example, the first-level parent features with non-null or non-zero scores are ranked by descending overall score.

Multiple first-level parent features in the ranking may be grouped under a second-level parent feature (operation 406) in the feature hierarchy. For example, the ranking may include two or more first-level parent features that are grouped under a second-level parent features that represents a common or overlapping meaning in the first-level parent features.

When the same second-level parent feature is associated with multiple first-level parent features in the ranking, one of the first-level parent features is selected for inclusion in the ranking based on the overall score (operation 408). For example, the first-level parent feature with the highest overall score is included in the ranking, and remaining first-level parent features grouped under the second-level parent feature are removed from the ranking. Operations 406-408 may be repeated until the ranking includes at most one first-level parent feature grouped under a given second-level parent feature in the feature hierarchy.

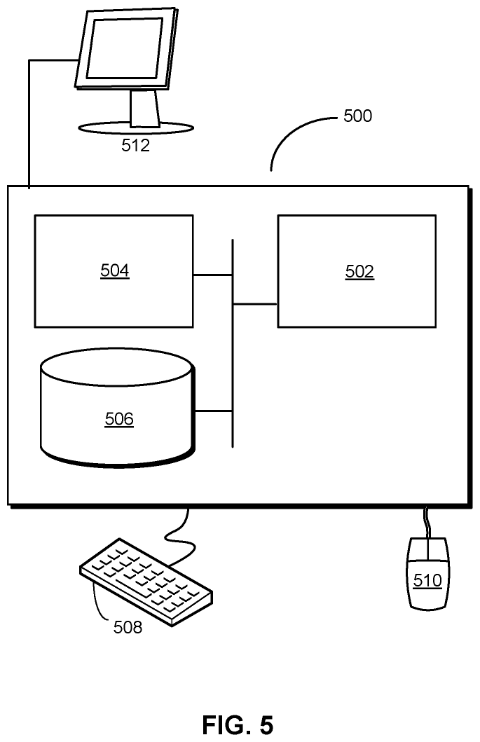

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes an analysis apparatus and a management apparatus, one or more of which may alternatively be termed or implemented as a module, mechanism, or other type of system component. The analysis apparatus determines output of a machine learning model, which includes a score generated by the model based on features inputted into the model and feature importance metrics representing effects of the features on the score. Next, the analysis apparatus maps the features to elements in a feature hierarchy that groups the features under a first level of parent features. The analysis apparatus also generates a ranking of the first level of parent features based on the feature importance metrics. The analysis apparatus then combines, based on the ranking, feature values of the mapped features with a set of insight templates to produce a list of narrative insights. Finally, the management apparatus outputs the list of narrative insights in a user interface.

In addition, one or more components of computer system 500 may be remotely located and connected to the other components over a network. Portions of the present embodiments (e.g., analysis apparatus, management apparatus, data repository, machine learning platform, etc.) may also be located on different nodes of a distributed system that implements the embodiments. For example, the present embodiments may be implemented using a cloud computing system that generates human-readable narrative insights from output produced by a set of remote machine learning models.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining output of a machine learning model, wherein the output comprises a score generated by the machine learning model based on features inputted into the machine learning model and feature importance metrics representing effects of the features on the score;
mapping, by one or more computer systems, the features to elements in a feature hierarchy that comprises groupings of the features under a first level of parent features;
generating, by the one or more computer systems, a ranking of the first level of parent features based on the feature importance metrics;
combining, by the one or more computer systems based on the ranking, feature values of the mapped features with a set of insight templates to produce a list of narrative insights, wherein each narrative insight in the list comprises a natural language description of a factor that contributes to the output of the machine learning model; and
outputting, by the one or more computer systems, the list of narrative insights in a user interface for consuming the output of the machine learning model.

2. The method of claim 1, further comprising:
converting the score into a natural language explanation of a significance of the score; and
including the natural language explanation in the outputted list of narrative insights.

3. The method of claim 2, wherein converting the score into the natural language explanation of the significance of the score comprises:
identifying a range of scores containing the score; and
retrieving the natural language explanation of the significance of the range of scores.

4. The method of claim 1, wherein mapping the features to the elements in the feature hierarchy comprises:
associating a feature value of a feature inputted into the machine learning model to an identifier for the feature in the feature hierarchy; and
transforming one or more of the feature values.

5. The method of claim 4, wherein mapping the features to the elements in the feature hierarchy further comprises:
calculating one or more metrics from the one or more of the feature values grouped under a parent feature in the feature hierarchy.

6. The method of claim 5, wherein the one or more metrics comprise at least one of:
a change in a feature value over time;
a ratio of two feature values; and
an aggregate value of a feature for a set of entities associated with scores outputted by the machine learning model.

7. The method of claim 1, wherein generating the ranking of the first level of parent features based on the feature importance metrics comprises:
for each parent feature in the first level of parent features, aggregating one or more of the feature importance metrics for one or more features grouped under the parent feature into an overall score for the parent feature; and
generating the ranking of the first level of parent features based on the overall score.

8. The method of claim 7, wherein generating the ranking of the first level of parent features based on the feature importance metrics further comprises:
when two or more parent features in the ranking are grouped under an additional parent feature in a second level of the feature hierarchy, selecting one of the two or more parent features for inclusion in the ranked first level of parent features based on the overall score.

9. The method of claim 7, wherein aggregating the one or more of the feature importance metrics for the one or more features grouped under the parent feature into the overall score for the parent feature comprises at least one of:
selecting a highest feature importance metric associated with the one or more features as the overall score; and
determining the overall score based on a statistic calculated from the one or more feature importance metrics.

10. The method of claim 1, wherein combining the features values of the mapped features with the set of insight templates to produce the list of narrative insights comprises:
inserting feature values of one or more features mapped to a parent feature in the feature hierarchy into positions of the one or more features in an insight template for the parent feature.

11. The method of claim 1, wherein outputting the list of narrative insights comprises at least one of:
ordering the narrative insights in the list to reflect the ranking; and
applying one or more filters to the list of narrative insights prior to outputting the list of narrative insights.

12. The method of claim 11, wherein the one or more filters comprise at least one of:
one or more parent features to omit from the outputted list of narrative insights;
a maximum number of narrative insights to output; and
a minimum change in a feature.

13. A system, comprising:
one or more processors; and
memory storing instructions that, when executed by the one or more processors, cause the system to:
determine output of a machine learning model, wherein the output comprises a score generated by the machine learning model based on features inputted into the machine learning model and feature importance metrics representing effects of the features on the score;
map the features to elements in a feature hierarchy that comprises groupings of the features under a first level of parent features;
generate a ranking of the first level of parent features based on the feature importance metrics;
combine, based on the ranking, feature values of the mapped features with a set of insight templates to produce a list of narrative insights, wherein each narrative insight in the list comprises a natural language description of a factor that contributes to the output of the machine learning model; and
output the list of narrative insights in a user interface for consuming the output of the machine learning model.

14. The system of claim 13, wherein the memory further stores instructions that, when executed by the one or more processors, cause the system to:
convert the score into a natural language explanation of a significance of the score; and
include the natural language explanation in the outputted list of narrative insights.

15. The system of claim 14, wherein converting the score into the natural language explanation of the significance of the score comprises:
identifying a range of scores containing the scores; and
retrieving the natural language explanation of the significance of the range of scores.

16. The system of claim 13, wherein mapping the features to elements in the feature hierarchy comprises at least one of:
associating a feature value of a feature inputted into the machine learning model to an identifier for the feature in the feature hierarchy;
transforming one or more of the feature values; and
calculating one or more metrics from the one or more of the feature values grouped under a parent feature in the feature hierarchy.

17. The system of claim 13, wherein generating the ranking of the first level of parent features based on the feature importance metrics comprises:
for each parent feature in the first level of parent features, aggregating one or more of the feature importance metrics for one or more features grouped under the parent feature into an overall score for the parent feature;
generating the ranking of the first level of parent features based on the overall score; and
when two or more parent features in the ranking are grouped under an additional parent feature in a second level of the feature hierarchy, selecting one of the two or more parent features for inclusion in the ranking based on the overall score.

18. The system of claim 17, wherein aggregating the one or more of the feature importance metrics for the one or more features grouped under the parent feature into the overall score for the parent feature comprises at least one of:
selecting a highest feature importance metric associated with the one or more features as the overall score; and
determining the overall score based on a statistic calculated from the one or more feature importance metrics.

19. The system of claim 13, wherein outputting the list of narrative insights comprises at least one of:
ordering the narrative insights in the list to reflect the ranking; and
applying one or more filters to the list of narrative insights prior to outputting the list of narrative insights.

20. A non-transitory computer-readable storage medium storing instructions that when executed by a computer cause the computer to perform a method, the method comprising:
determining output of a machine learning model, wherein the output comprises a score generated by the machine learning model based on features inputted into the machine learning model and feature importance metrics representing effects of the features on the score;
mapping the features to elements in a feature hierarchy that comprises groupings of the features under a first level of parent features;
generating a ranking of the first level of parent features based on the feature importance metrics;
combining, based on the ranking, feature values of the mapped features with a set of insight templates to produce a list of narrative insights, wherein each narrative insight in the list comprises a natural language description of a factor that contributes to the output of the machine learning model; and
outputting the list of narrative insights in a user interface for consuming the output of the machine learning model.
